(19) United States
(12) Patent Application Publication
(10) Pub. No.: US 2026/0359754 A1
(43) Pub. Date: Nov. 12, 2026

(54) OUTLIER DETECTION AND MODIFICATION OF AI GENERATED TAX WORKFLOW

(71) Applicant: Vertex, Inc., King of Prussia, PA (US)

(72) Inventor: Christopher Zangrilli, Trappe, PA (US)

(21) Appl. No.: 19/200,206

(22) Filed: May 6, 2025

(51) Int. Cl. G06Q 10/0633; G06Q 40/10

(52) U.S. Cl. CPC G06Q 10/0633; G06Q 40/10

(57) ABSTRACT

A computing system is provided that executes a tax application virtual assistant program having a workflow orchestrator configured to receive a workflow creation command, send a request to a workflow creation agent of a generative language model to thereby generate a new workflow, receive a verify workflow command, and in response instantiate an outlier detection module. The outlier detection module is configured to identify a comparison set of workflows based on one or more comparison parameters, compute statistical values for a plurality of encoded features extracted from the comparison set of workflows, compute new workflow values for the plurality of encoded features for the new workflow, compare the new workflow values to the statistical values to thereby identify at least one outlier value for an outlier feature of the plurality of encoded features, and display a graphical representation of the outlier value and outlier feature.

### BACKGROUND

In the modern tax information ecosystem, global businesses that sell goods and services in a variety of countries and localities, either online or via physical stores, typically configure their point of sale and/or enterprise resource management computing systems to engage with enterprise tax technology provider platforms that automate and digitize preparation of tax returns and filings to the various local tax authorities, thereby ensuring global compliance with tax laws. These same businesses typically retain multinational legal and accounting firms to give them professional advice regarding how to set up their corporations, prepare and file their corporate tax returns, respond to audits, and generally comply with local tax laws in each jurisdiction. Information in each of the legal and accounting firms and the tax technology provider platforms tends to become siloed, since technical challenges for information exchange exist.

Language models have been developed that can be leveraged to provide users with a natural language interface for answering questions. To expand the functionality of language models, agentic machine learning systems have been proposed that respond to a user's query received via a language model chat interface, by employing one or more language model agents configured perform certain specialized tasks defined in a workflow. To date, the application of such language models and agentic systems to tax technology has been limited or nonexistent.

Configuring an agentic generative AI system that utilizes such a generative language model to perform a tax related workflow is a complicated endeavor, both for global entities selling a variety of products in countries across the globe, and for smaller companies with a few locations in one tax jurisdiction. Errors that crop up in an AI workflows can result in misclassification of products or services, errors in compliance reports, mis-calculation and mis-payment of taxes due, and accounting errors. Further, AI workflows that are not well conceived can take too long to run, produce results that are difficult to understand even if accurate, and yield sub-optimal results. Thus, although technical solutions are currently lacking, opportunities exist to improve the generation of AI workflows.

### SUMMARY

To address the above issues, computerized systems and methods are provided as described herein. In one aspect, the system includes a processing circuitry and associated memory storing instructions that when executed by the processing circuitry cause the processing circuitry to implement a tax application virtual assistant program having a workflow orchestrator. The workflow orchestrator is configured to receive a workflow creation command at the workflow orchestrator, send a request to a workflow creation agent of a generative language model to thereby generate a new workflow in response to receiving the workflow creation command, and receive a verify workflow command, and in response instantiate an outlier detection module. The outlier detection module is configured to identify a comparison set of workflows based on one or more comparison parameters, compute statistical values for a plurality of encoded features extracted from the comparison set of workflows, compute new workflow values for the plurality of encoded features for the new workflow, compare the new workflow values to the statistical values to thereby identify at least one outlier value for an outlier feature of the plurality of encoded features, and display a graphical representation of the outlier value and outlier feature.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 is a schematic diagram of a computing system an agentic tax platform according to one example implementation of the present disclosure.

FIG. 2 is a schematic diagram of the computing system of FIG. 1, further illustrating workflow orchestrator being used to generate a new workflow using a chat interface of a graphical user interface.

FIG. 3 is a schematic diagram illustrating performing outlier detection by comparing a new workflow with similar workflows on the platform for similarly situated customers, and generating a modified new workflow based on the identified outlier values and features.

FIG. 4A-4C illustrate example GUIs of the computing system of FIG. 1, showing outlier detection in a radar plot in FIG. 4A, workflow modification that reduce outliers in the radar plot in FIG. 4B, and principal component analysis that illustrates outliers in FIG. 4C.

FIG. 5 illustrates a flow chart of a method according to one example implementation of the present disclosure.

FIG. 6 illustrates an example computing system that can be used as the computing system of FIG. 1.

### DETAILED DESCRIPTION

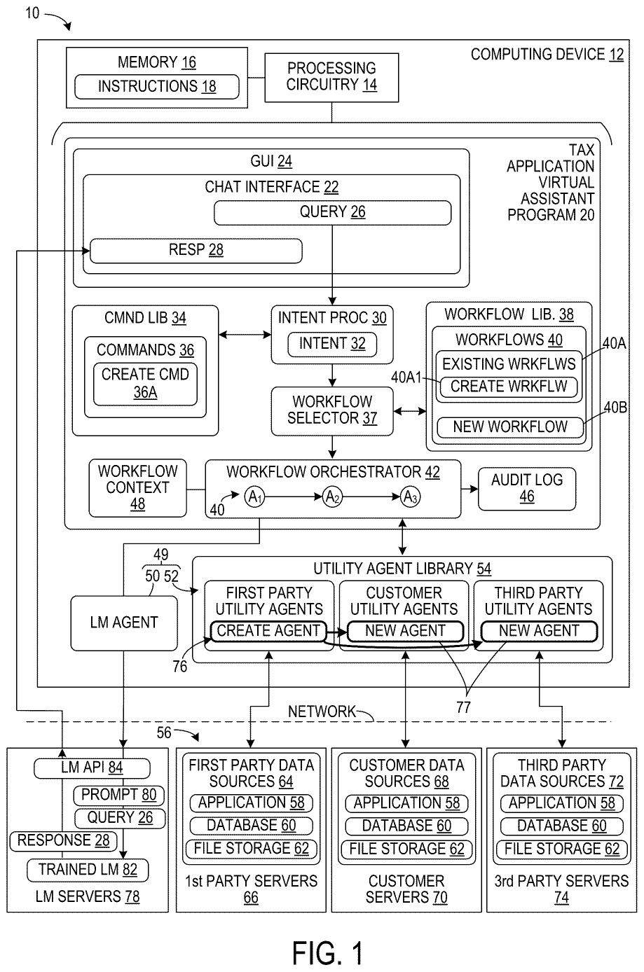

FIG. 1 generally illustrates a computing system 10 including one or more computing devices 12. Each computing device 12 includes processing circuitry 14 and memory 16 storing instructions 18 that when executed by the processing circuitry 14 cause the processing circuitry 12 to perform the functions described herein, to thereby function as a tax platform. It will be appreciated that computing device 12 may be a plurality of computing devices configured as servers that operate in coordinated fashion as a tax platform configured to respond to tax related queries from users.

As shown, the processing circuitry 14 is configured to execute a tax application virtual assistant program 20. The tax application virtual assistant program 20 is configured to display a chat interface 22 of a graphical user interface 24, on a display associated with the computing device 12. The tax application virtual assistant program 20 is configured to receive a query 26 from a user, and generate a response 28 that is displayed in the chat interface 22. Alternatively, other forms of user interface may be provided, such as a command line interface, search bar, etc., instead of or in addition to chat interface 22.

Query 22 is processed by an intent processor 30, which predicts an intent 32 of the user based on the query 26, and selects a command 36 associated with the predicted intent 32 from a command library 34. The command 36 may be, for example, a create utility agent command 36A, which is called when the user intent 32 is detected as desiring to create a new AI agent on the platform. Alternatively, the command may be to perform a tax related operation using agents of the platform.

Based on the selected command, a workflow selector 37 selects from a workflow library 38 an associated workflow 40. The workflow 40 may be an existing workflow 40A selected from a suitable workflow for use with the tax application virtual assistant program 20. If the user intent 32 is to create a new workflow, then a create agent workflow 40A1, which is one of the existing workflows 40A, is selected. The create agent workflow 40A1 is configured to create a new workflow 40B that utilizes an utility agent 52 on the tax platform. Alternatively, the workflow selector 37 may select another existing workflow 40A from the workflow library 38 based on the resolved intent 32, such as a workflow 40 to compute use taxes, reconcile receipts with gross income on a tax form, verify the content of exemption certificates, etc.

The selected workflow 40 is passed to a workflow orchestrator 42, which in turn calls the appropriate agents 49 among language model agent 50 and utility agents 52 to implement the workflow 40. The workflow 40 can be a directed acyclic graph including a plurality of nodes. For each node the orchestrator 42 typically instantiates one or more agents to accomplish a subtask, and passes a computation result to a next node in the directed acyclic graph. In a simplest implementation, the workflow is a linear series of nodes. Thus, the orchestrator 42 is configured to instantiate a plurality of utility agents 52 to perform tasks over a series of successive nodes in the workflow 18. The utility agents 52 are selected from a utility agent library 54. Actions performed during execution of the workflow 40 are logged by the workflow orchestrator 42 in an audit log 46. Further, context from interactions with the agents 49 at each node can be stored in a workflow context 48, which is passed with read write privileges to each successive node in the workflow 40. In this way, state can be maintained and communicated among the agents 49 involved in the workflow 40.

Utility agents 52 have skills and logic that enable them to access data sources 56, perform operations on the data at each node, and pass the result to a following node in the workflow 40. In particular, the utility agents 52 are configured to access tax data and tax logic of a tax database 58, application 60, and/or file storage 62, at each data source 56. The data sources 56 can include first party data sources 64 executed on first party servers 66, customer data sources 68 executed on customer servers 70, and/or third party data sources 72 executed on third party servers 74.

In addition to the workflow creation workflow 40A1, which functions as a workflow generation tool, as described above, the computing system 10 further includes an agent generation tool 76. The workflow generation tool embodied by the workflow creation workflow 40A1 enables a third party to create new workflows 40B using the utility agent library 54 of tax agents and a simple logic editor, and add them to a workflow library 38 of available workflows 40. The agent generation tool 76 allows third parties to define new agents 77 and add them to the utility agent library 54. A permissions system can be provided for customers and third parties to control access to the agents and workflows to authorized users. The customers or third parties can use the permissions system to restrict access to a set of authorized users including (1) the third party's own employees, (2) customers that are clients of the third party, or (3) one or more specified customers of the platform, (4) all customers of the platform. Alternatively, the permissions level may be set to allow any user having access to the platform to use agents.

Information collected, processed, and output from the utility agents 52 can be passed via language model agent 50 along with the query 26 from the user and a prompt 80 to a trained language model 82 executed on language model servers 78, over a computer network such as the Internet. The generative language model can be a reasoning model configured to generate workflows, such as GPT-o1 by OpenAI, Claude 3.7 Sonnet by Anthropic, DeepSeek-R1 by DeepSeek, and Grok 3 by xAI. The workflows can be a series of intermediate reasoning steps that can be represented as a plurality of nodes linked in a directed acyclic graph, each of the nodes having an associated agent configured to perform an operation associated with the node, a result of an operation of a prior node in the graph being passed to a subsequent node. The prompt 80 can be engineered to include all or part of the workflow context 48 and a language model instruction, e.g., “Answer the query in view of the following context.” This input data is typically sent via a language model application programming interface (API) 84, and causes the trained language model 82 to generate the response 28 to the query 26. Once the response 28 is generated, it is sent back from the language model server 82 to the chat interface 22 for display to the user. The response can include, for example, a confirmation that the new agent 77 has been created and/or that the new workflow 40B has been created.

In this way an ecosystem can be created for tax related AI agents and workflows that operate on an enterprise tax technology provider platform. Third parties can create new agents 77 and new workflows 40B using the tax AI agent creation tool 40 and the workflow creation tool 76, and offer new agents 77 and new workflows 40B to customers via a marketplace interface hosted on the platform.

The new workflows 40B can include nodes that instantiate the new agents 77. The new agents 77, like any utility agent 54, can be configured to interrogate a specified data object located on one of the data sources 52. The third party creating the new agent 77 can specify appropriate permissions to enable the new agent 77 to interact with a data object hosted at the third party data source 72. The new agent 77 can be configured to analyze the interrogated data object and generating output from the analysis. By way of example, the data object may be contained in a tax determination, compliance, or e-invoicing database 60, which is configured and can be used to generate data on the platform. The new agent 77 can be configured to access customer specific private data, or platform hosted non-private data such as datasets in a tax rate and rule database, a taxability database, a forms database, etc. Third parties and their customers can also configure the new agent 77 to interact with customer-private data such as e-invoicing data (customer data generated with a third party vendor) or a chart of accounts (customer private data), for example. The new agent 77 can be configured to generate a report over these such sources. The new agent can be provisioned with programing logic to perform certain actions on this data. In one specific example, the new agent 77 can be configured to perform analysis in the form of reconciliation and tax sensitization on a generated report for a specified period of time, such as a given month. Using the computing system 10, agentic logic such as this can be packaged into an agent by a third party, such as an accounting firm, and offered to other companies, such as other customers of the accounting firm.

For data sources 56, the following example data sources can be used.

### Data Sources:

1. Customer data
2. Tax determination configuration data
3. Tax determination generated data (transactions)
4. Compliance configuration data
5. Compliance generated data (returns)
6. e-Invoicing configuration data
7. e-invoicing generated data (transactions)
8. First party/non-private data
9. Rate & rule database
10. Taxability database
11. Forms database

For programming logic included at each node in workflows 40, the following example actions can be used.

### Actions:

1. Scheduling
2. Generate report (with Report filter)
3. Export/output formatting
4. Analyze Logic
5. Summarize using Generative AI
6. Notifications
7. Human-in-the-Loop (HIL)

For programming logic included at each node in workflows 40, the following example execution attributes can be used.

### Execution Attributes:

1. Execution mode (Interactive, Autonomous)
2. HIL target (First Party, Customer, Third Party)

For the workflows 40, the following example workflow characteristics can be adopted, in one implementation.

### Workflows:

1. Workflows define a sequential ordering of actions accomplished by program logic with the possible aid of utility agents or language model agents
2. Each action is treated as a step in a workflow, with each execution step logged to an audit log, and the result of each execution step passed to the next execution step, the steps corresponding to nodes in a directed acyclic graph.
3. The number of steps (or nodes) in the workflow can be limited to a predetermined number to establish a limit on the computational burden of each workflow. The limit, may, for example, be 10 steps.

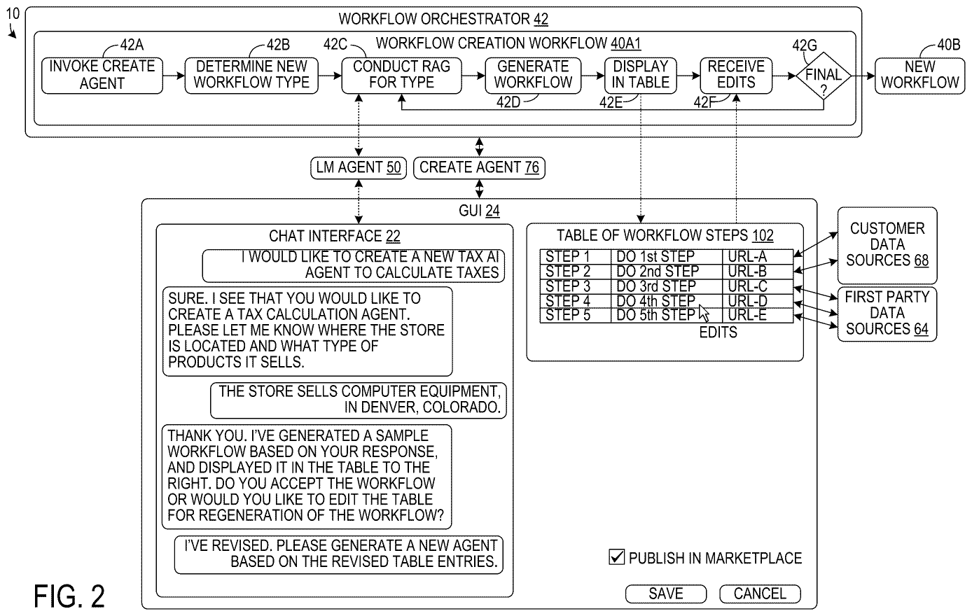

Thus, it will be appreciated that workflows 40 are a set of sequential actions that form the steps of a workflow 40. Workflows are created by inputting a textual description of the work to be done by the tax application virtual assistant program into the chat interface 22. The description is interpreted by a trained generative language model 82 to understand the intent, clarify unknowns, and then represent a draft sequence of actions on the screen in a table view, as shown in FIG. 2.

FIG. 2 illustrates the workflow orchestrator 42 of FIG. 1 implementing the workflow creation workflow 40A1. According to workflow creation workflow 40A1, an agent is invoked (i.e., instantiated) at 42A, which is configured to determine the new workflow type at 42B. The workflow then selects a RAG prompt template for the determined workflow type and calls language model agent 50 loaded with a RAG prompt template to conduct retrieval augmented generation for the determined workflow type at 42C. The language model agent 50 engages in a conversation via the chat interface 22 shown in FIG. 1 with the user in an attempt to identify blank information in the RAG prompt template. Continuing with FIG. 2, once sufficient information has been elicited to generate a workflow 40 for the new workflow 40B, the workflow creation workflow 40A1 calls language model agent 50 to generate a new workflow 40B at 42D. The new workflow 40B is displayed in a table at 42E. This table is depicted in the GUI 24 at 102. The GUI 24 can be configured to enable the user to edit the sequence of steps in the new workflow 40B shown in the table by moving actions, removing actions, editing actions, and adding actions in the sequence, through click and drag or copy and paste actions on the table, for example. This is illustrated in FIG. 2 as a pointer making EDITS, as shown. As shown, each action in the table of workflow steps 102 includes a step identifier, an action description, and a URL for a data source used by the action. The URLs may point to any of data sources 52, and in the illustrated example point to customer data sources 68 and first party data sources 64. Once these edits are received at 42F, the user is asked by the interface to confirm whether the workflow is final, or whether additional revisions should be made. For additional revisions, the workflow returns to conduct further RAG at 42C. If user input confirms the workflow is final, the workflow is output as new workflow 40B.

An example chat session for creating a new workflow is shown in chat interface 22. In the example, a user inputs a query indicating that the user would like to create a new tax AI agent to calculate taxes. The language model agent 50 responds with an intent acknowledgement (“Sure I see that you would like to create a tax calculation agent.”) and with a request for further relevant information regarding the geographic location and type of products sold (“Please let me know where the store is located and what type of products it sells”). The user replies that the store is in Denver, CO and the products are computer equipment. The workflow is generated based on this information and steps are displayed in table of workflow steps 102. A reply is generated (“Thank you. I've generated a sample workflow base don your response, and displayed it in the table to the right. Do you accept the workflow or would you like to edit the table for regeneration of the workflow.”) After revising the entries in the table the user responds with a request for regeneration (“I've revised. Please generate a new agent based on the revised entries.”) This command will be executed by the workflow creation workflow 40A1 and a modified workflow displayed in the table of workflow steps 102 in the GUI 24.

Example analysis logic that can be included in each node in a workflow 40 is discussed below.

### Analyze Logic Action

The Analyze Logic action is a specially defined action that can be applied to an intermediate output or a report/export. The logic will be a set of generative language model prompts and context that can be passed into language model 50 to perform analysis of tax report data, by incorporating tax specific instructions. The first party data source 64 includes a library of Analyze Logic actions for users and will license the ability for customers or third party partners to add to that library. This logic will focus on tax analysis of the reports to identify anomalies, patterns, and answer tax questions.

It will be appreciated that some nodes in a workflow 40 may define human in the loop actions. Examples are discussed below.

Human-in-the-Loop (HIL) action

The HIL Action is a specially defined action that creates an interactive session to have a human review and human action. In one implementation, the HIL action can have 2 modes—interactive and review. The interactive mode will pause the workflow of the tax agent until the session is completed, while the review mode can only occur as the last step in a workflow and will end the workflow once the session is started. In both modes a web screen will be exposed to a user that will allow for download and review of the output from the previous step in the workflow. In the interactive mode, there will be a set of HIL actions that can be taken, such as continue with no change, continue with changed document, continue with an additional document.

The HIL screen will also be governed by the execution attributes, which could specify that the human interactive session is provided to the customer, a third party, or the first party. Access to this screen will be further defined by roll-based access, which would identify which users can access the HIL screen and in the case of a partner or the first party, also include a list of customers for which a user can process HIL.

Computing system 10 is configured to display a marketplace interface to enable users to browse agents and workflows that have been created by customers and third parties. An example follows.

### Tax Agent Marketplace

Each new utility agent 77 and new workflow 40B created by a customer or third party is assigned a unique name and the option of being visible to the users from one company or published into a marketplace. The marketplace will enable an ecosystem on the platform of the first party that will allow first party, customers, and third parties to co-create new agents 77 and new workflows 40B and make new agents 77 and new workflows 40B and available for the community to use. The marketplace will track usage and will enable other parts of the system to trigger recommendations to users. While these new third party and customer agents 77 and workflows 40B will be exposed in the marketplace, their execution may be limited by the entitlements that an account has and may perform differently from one account to another due to the different data sets/data objects that an account may have.

The GUI 24 may take various forms, and have various modes of interaction, as follows.

### User Experience (UX)

In one example, the GUI can have multiple modes of interaction, as follows.
1. Agent Creation Mode
2. Marketplace Mode
3. Interactive Execution Mode

Each of these modes is tailored for a specific workflow, with the first being tailored for the create agent workflow, the second being tailored for a workflow in which a user selects an agent and/or workflow to use, and the third a mode in which the user is implementing a selected workflow. The workflows and agents can be created for use in the field of indirect tax reporting, or for use in other indirect tax processes.

### Agent Creation Mode

In this mode, the user will be presented with chat interface 22, which will prompt the user for a variety of inputs such as name, actions, data sources, and any AI processing, in RAG style using the RAG template discussed above. These inputs will be processed by the language model agent 50 using the language model 82 to understand the intent and develop a plan of execution steps or actions (candidate workflow steps). The steps or actions will be displayed in a table on the screen, as shown at 102 discussed above. The user will have the ability to modify the steps through the conversational chat interface 22 or by directly modifying data in the table 102, with modifications on the actions or order of activities, through copy and paste, click and drag, or directly typing into the table, for example, as briefly mentioned above. Utility agents 52 and workflows 40 can perform actions such as setting report criteria, running reports, translating output formants, summarizing reports, performing AI analysis of reports, and time/day scheduling. Other actions are also contemplated.

After a newly generated workflow 40B and/or new utility agent 77 is agreed to by the user (e.g., at 42G discussed above), it can be saved into a package with a name. According to a default setting, this package is only available to users of the account under which it was created. However, there is an option selectable (see “Publish to Marketplace” selector in FIG. 2) by the user to make the package available in a marketplace for users of other accounts (e.g., other customers or other third parties) to access. This agent package will have permissions associated to it, as read-only in the account, and will have access to the data objects and actions that are enabled by license entitlement in each user's account that uses the package.

### Interactive Execution Mode

In the Interactive Mode, agents and workflows included in packages that have been generated and stored in the above-described manner can be executed for testing. After testing is complete, the agent can be marked for autonomous execution, which triggers the agent to execute based upon user-specified conditions that bound to the package, such as schedule conditions (once a month, twice a month, etc.).

An enhanced GUI may be provided to handle the Analyze Logic action. This will expose a library of first party Analyze logic and approved customer and/or partner logic. Each logic segment will be named and described, with the support for searching. Upon having an additional license entitlement, the user will be able to create Analyze Logic. Analyze Logic will be included in a package having a name, description, prompt, meta-prompt, and additional context that is either a place holder to point to an intermediate file or static context. The context will be saved in a first party database 60, while the other pieces will be stored in a first party relational database 60. The platform can execute the workflows with a combination of human-in-the-loop and automated analysis of the Analyze Logic to help govern proper use and stop inappropriate logic.

The Interactive Execution Mode will run in the cloud on first party server 66 and can, for example, use a REACT® technology stack for the GUI 24. The underlying business logic can be a combination of a wizard workflow and generative AI intent processing to create an agent task plan or workflow. The packaging of this will be serializing the tasks into a data object that is stored in a database for future retrieval. Underlying the execution of the user created new workflow 40B is a collection of utility agents and an orchestrator 42, as described above. Typically, one utility agent is provided for each action category, i.e., one utility agent is provided for each node in the workflow 40. The orchestrator 42 loads the user-defined workflow, and interrogates the scheduling and permissions to determine if it should run. If the orchestrator 42 decides to run, it will use the workflow 40 to determine which utility agents 52 to call and will pass in the saved information. If Analyze Logic is part of the execution plan, the language model agent 50 will pass the intermediate file(s) and Analyze logic package to the language model 82 for processing. The output from each step will be stored on a file system that is permissioned for the user account. This area on the file system will be able to be used by the orchestrator 42 and the utility agents 52 to complete the new workflow 40B and provide a link to the end output to the user. This can be emailed to the user or displayed on the screen. Each execution of the agent workflow will be versioned, and an audit log will be retained to capture all steps taken.

### Marketplace Mode

In this mode the GUI 24 is configured to display available utility agents 52 and workflows 40 and enables a user to browse and select utility agents 52 and workflows 40 to be used in the user's account. The workflows 40 and utility agents 52 will be organized by a grouping category and will allow for browsing or searching by name or creator. The use of any utility agents 52 selected in the marketplace will be tracked, with usage metrics available to be published. In some versions, the workflows 40 and agents 52 are packaged together as an “agent”. That is, a workflow that actually calls a one or more language model agents and utility agents to perform an operation can be offered as an “agent” in this embodiment of the system. Once utility agent 52 or workflow 40 is selected, the agent task plan (i.e., workflow steps) will be displayed, and the GUI enables the user to customize the task plan by changing any input parameters as desired, as discussed in relation to FIG. 2. While the input parameters are customizable to point to customer data, for example, the steps and order of the plan typically are not editable in the Marketplace Mode-which helps the utility agents 52 and workflows 40 on offer to perform as their creators intended. Upon saving the updated agent or workflow package to the account, it can be run in interactive execution mode or run autonomously.

The marketplace mode runs in the first party cloud on first party servers and can use a REACT® technology stack for the GUI. The underlying business logic is (1) browse workflows and/or agents, select workflows and/or agents, and (3) save a local version of a selected workflow and/or agent having the task plan. The packaging of the local version will be serializing the input with the original agent package and will be stored in a database for future retrieval. Underlying the execution of a workflow 40 will be a collection of utility agents, typically one for each action category, and an orchestrator 42. The orchestration agent will load the user define agent workflow, interrogate the scheduling and permissions to determine if it should run. If the orchestration agent decides to run, it will use the agent workflow to determine which utility agents to call and will pass in the saved information. The output from each step will be stored on a file system that is permissioned for the user account. This area on the file system will be able to be used by the orchestration agent and the utility agents to complete the workflow and provide a link to the end output to the user. This can be emailed to the user or displayed on the screen. Each execution of the agent workflow will be versioned, and an audit log will be retained to capture all steps taken.

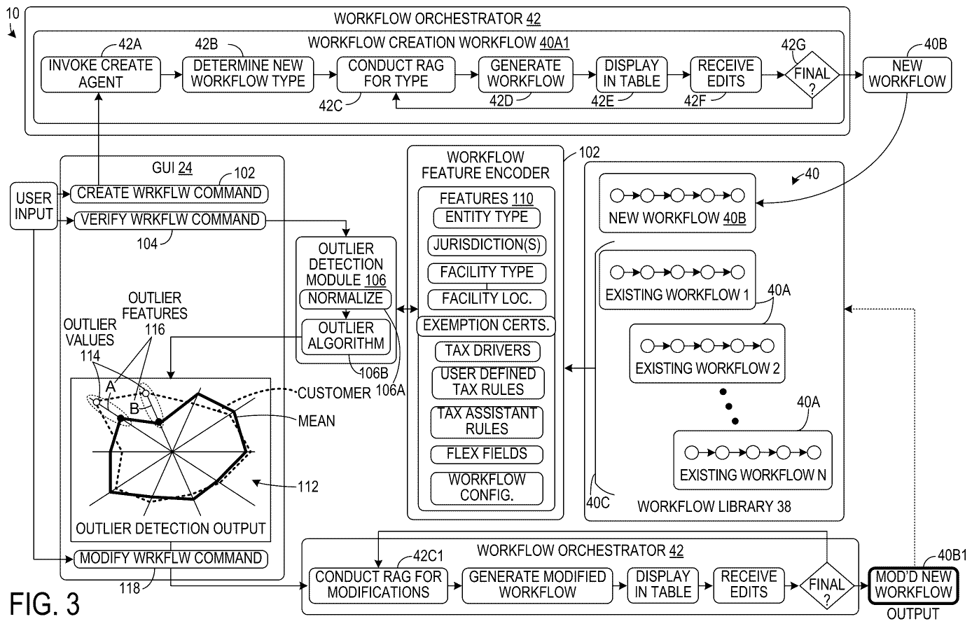

FIG. 3 illustrates computing system 10 configured with an outlier detection functionality, which can detect outlier elements of workflows and suggest modifications to a workflow. As shown, the processing circuitry 14 of computing system 10 is configured to receive a workflow creation command 102 at the workflow orchestrator 42 from user input received via GUI 24. The workflow creation command 102 may be input into chat interface 22 as discussed previously, or may be input via an alternative input mechanism, such as a text input field or a selector. The processing circuitry 14 of computing system 10 is further configured to send a request to a workflow creation agent 42A of a generative language model 82 to thereby generate a new workflow 40B in response to receiving the workflow creation command 102.

The processing circuitry 14 is further configured to receive a verify workflow command 104 via GUI 24 (e.g., via chat interface 22 or other interface), and in response instantiate an outlier detection module 106. The outlier detection module 106 is configured to identify a comparison set 40C of workflows 40 based on one or more comparison parameters, compute statistical values 108 for a plurality of encoded features 110 extracted from the comparison set 40C of workflows 40, compute new workflow values for the plurality of encoded features 110 for the new workflow 40B, compare the new workflow values to the statistical values to thereby identify at least one outlier value for an outlier feature of the plurality of encoded features, and display a graphical representation 112 of the outlier value 114 and outlier feature 116. The statistical values can be mean, median, mode, or combinations thereof for the values of the plurality of encoded features extracted from the comparison set of workflows, and are computed by a workflow feature encoder executed by the processing circuitry. The encoded features 110 can be entity type, jurisdiction, facility type, facility location, exemption certificates, tax drivers, user defined tax rules, tax assistant rules, flexible fields, and workflow configurations, or combinations thereof.

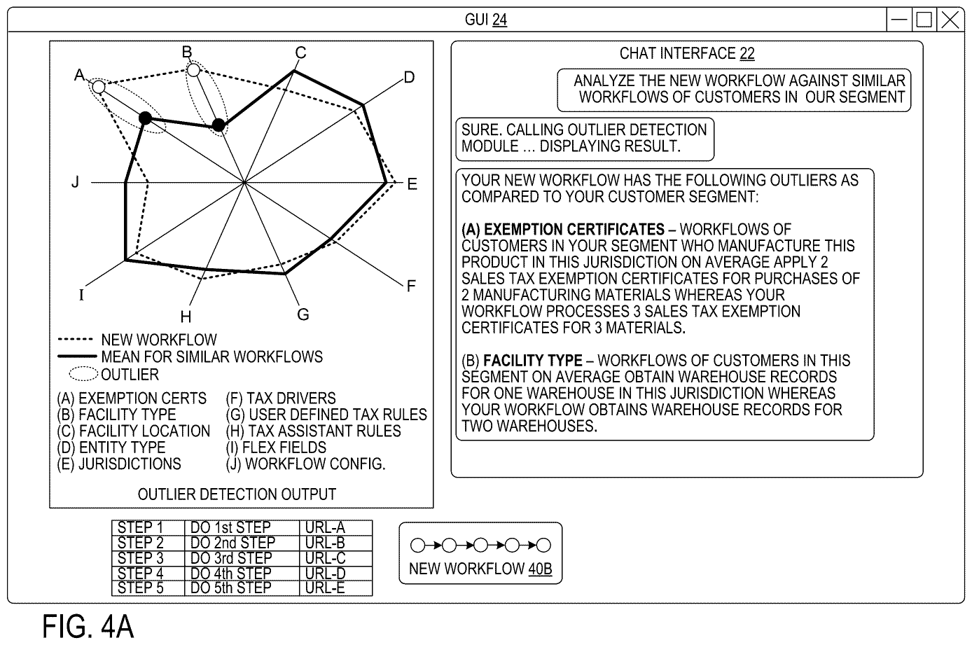

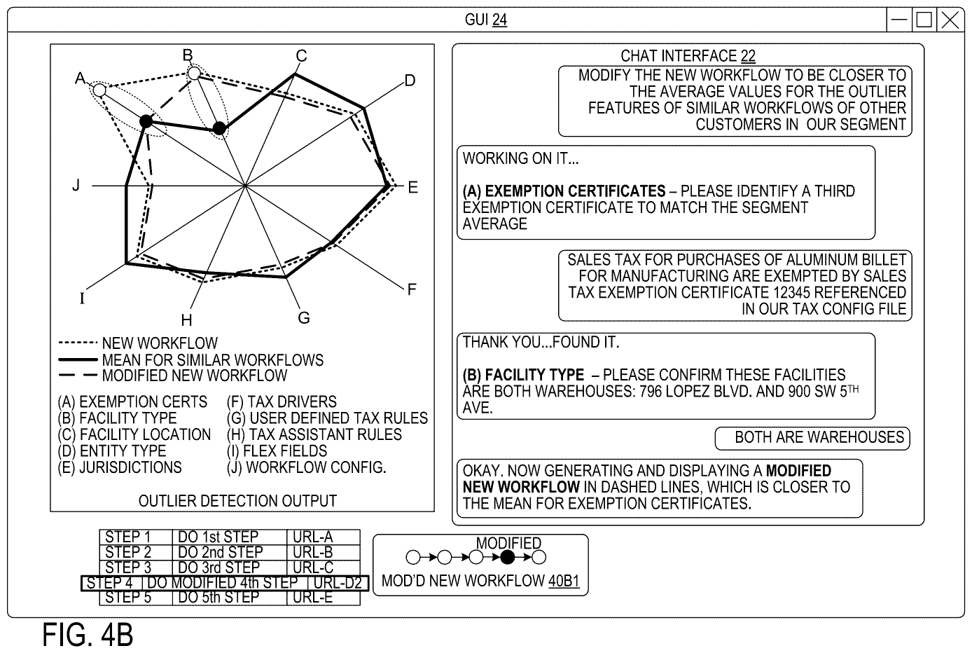

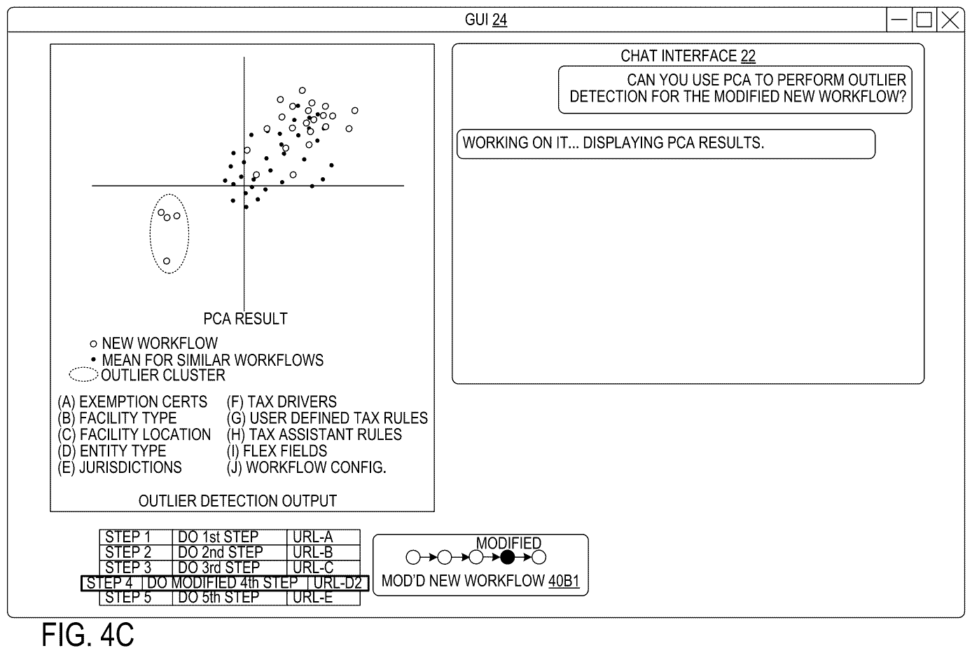

In the illustrated example, the graphical representation 112 of the outlier value 114 and outlier feature 116 is a radar chart that represents each of the plurality of features 110 as radially extending axis, and includes a visually distinguishable depiction of the outlier feature 114 and outlier value 116. A detailed view of the radar chart is provided in FIGS. 4A and 4B discussed below.

The processing circuitry 14 is further configured to receive a modify workflow command 118, and process the command using the workflow orchestrator 42, to thereby conduct retrieval augmented generation as shown at 42C1 using generative language model 82, and thereby generate a modified new workflow 40B1. In the same process as described above in relation to FIG. 2, the steps of the new workflow 40B1 can be displayed in a table within the GUI 24, and directly edited by the user, prior to acceptance as final by the user.

It will be appreciated that comparing the new workflow values to the statistical values to thereby identify at least one outlier 114 can be performed by an outlier detection algorithm 106B implemented by the outlier detection module 106 executed by the processing circuitry 14. The outlier detection module 106 is further configured to normalize, at 106A, the values prior to implementation of the outlier detection algorithm 106B. In one example, the normalization can be conducted on a 10 point scale according to the following normalization formula:

dimension(normalized)=((dimension count−min(dimension count))/(max(dimension count)−min(dimension count))*10

Alternatively other outlier detection algorithms can be used. For example, methods such as principal component analysis, K-Means clustering, density based spatial clustering of applications with noise (DBSCAN), Z-Score, local outlier factor (LOF), isolation forest, and minimum covariance determinant, could be used if appropriate to the data set features under analysis.

FIGS. 4A-4C illustrate three examples of GUI 24 in greater detail. In FIG. 4A, a user has requested, via the chat interface 22, that the computing system 10 analyze the new workflow generated in FIG. 3 against other similar workflows of customers in the same customer segment. The workflow orchestrator 42 is configured to call the outlier detection module 106 and feature encoder 102 to conduct this outlier analysis, as described above. In the illustrated example, the workflow is graphed on the radar chart, and a textual reply is displayed in the chat interface 22 explaining the detected outliers. A first outlier is that similar workflows for customers in the same segment on average apply two sales tax exemption certificates whereas the new workflow applies sales tax three exemption certificates. A second outlier is that similar workflows for customers in the same segment on average obtain warehouse records for one warehouse in this jurisdiction, whereas the new workflow obtains warehouse records for two warehouses. The radar plot shows these outliers at A and B.

FIG. 4B illustrates a GUI showing generation of a modification of the new workflow to hew closer to the mean for the customer segment. In the chat interface 22, the user requests computing system 10 to modify the new workflow 40B to be closer to the average values for the similar workflows of other customers in the same customer segment. The workflow orchestrator 42 coordinates with the language model agent 50 to generate a response. The workflow orchestrator 42 conducts response augmented generation (RAG), as described above at 42C in FIG. 3. First the language model agent 50 asks the user to identify a third exemption certificate to match the segment average for this feature. The user response that sales tax for purchases of aluminum billet for manufacturing are exempted by sales tax exemption certificate 12345 referenced in the customer's tax configuration file, which is saved in database 60 on customer servers 70. With that information, utility agents 52 are called by the workflow orchestrator 42 to retrieve the certificate and update the new workflow. A second RAG query is made by the language model 50, asking the user to clarify whether two addresses are both warehouses, in an attempt to lower the number of warehouses referenced by the workflow to the customer segment average of one warehouse. However, in this case the user responds that both addresses are warehouses, making reconciliation to the mean impossible.

Next, the workflow orchestrator modifies the new workflow to generate a modified new workflow 40B1 similarly to FIG. 3, and displays a reply in the chat interface explaining that the modified new workflow 40B1 has been generated, analyzed for outliers, and the outlier detection output displayed. As shown in dashed lines, the values for feature A (exemption certificates) now matches, but the values for feature B (facility types) does not match as the number of warehouses remains different. Thus, the “shape” of the feature values of the modified new workflow graphed on the radar plot more closely resembles the averages for the customer segment, but do not exactly match in this example. In other examples, exact matches may be possible. To achieve this closer match, FIG. 4B shows that Step 4 of the steps in the table has been modified to a be a modified 4^{th} step 4. This is also shown by a dark circle in the workflow, representing a modified step at the fourth node.

Turning now to FIG. 4C, in another example the outlier detection algorithm 106B can be a principal component analysis (PCA) algorithm and the graphical representation can be a two-dimensional plot of computed principal components of the plurality of features. In the illustrated example, the user requests via the chat interface that the modified new workflow 40B1 be analyzed using PCA, and in response the analysis is conducted and displayed. In the plot of the PCA result, an outlier cluster is visible, as shown in dashed lines. This represents the principal components that contribute to facility type mismatch discussed above. In one example, the user can select the cluster and obtain more information about those principal components.

It will be appreciated that to identify the relevant customer segment against which the outlier detection should be performed, it is also possible to analyze the process occurrence of configuration processes that would indicate if each customer is part of a segment or not. In one example implementation, the process occurrences can include:
1. number of times per month that registrations are added
2. number of times per month that exemption certificates are added
3. number of times per month that tax driver mappings are added
4. number of times per month that other configurations are added
5. number of times per month that other configurations are changed

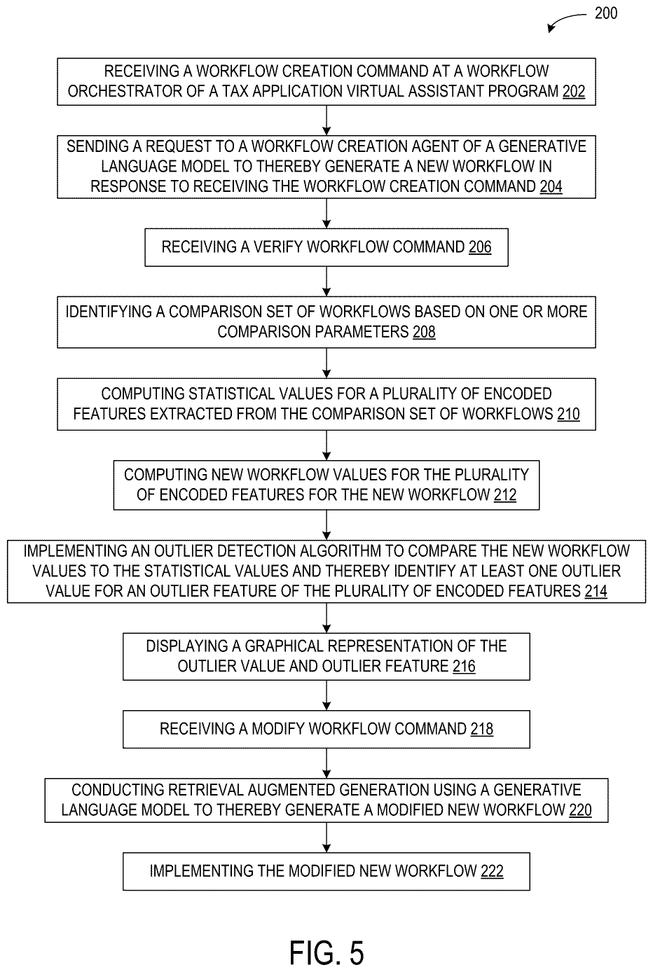

Turning now to FIG. 5, a computerized method for determining and addressing outliers in tax-related AI generated workflows is shown generally at 200. Method 200 can be implemented on computing system 10 described above, or on other suitable hardware and software. Method 200 includes, at 202, receiving a workflow creation command at a workflow orchestrator of a tax application virtual assistant program. At 204, the method includes sending a request to a workflow creation agent of a generative language model to thereby generate a new workflow in response to receiving the workflow creation command. At 206, the method includes receiving a verify workflow command. At 208, the method includes identifying a comparison set of workflows based on one or more comparison parameters. At 210, the method includes computing statistical values for a plurality of encoded features extracted from the comparison set of workflows. At 212, the method includes computing new workflow values for the plurality of encoded features for the new workflow. At 214, the method includes implementing an outlier detection algorithm to compare the new workflow values to the statistical values and thereby identify at least one outlier value for an outlier feature of the plurality of encoded features. At 216, the method includes displaying a graphical representation of the outlier value and outlier feature. At 218, the method includes receiving a modify workflow command. At 220, the method includes conducting retrieval augmented generation using a generative language model to thereby generate a modified new workflow.

As described above, the statistical values are mean, median, mode, or combinations thereof for the values of the plurality of encoded features extracted from the comparison set of workflows, and are computed by a workflow feature encoder executed by the processing circuitry. Further as described above, the encoded features are entity type, jurisdiction, facility type, facility location, exemption certificates, tax drivers, user defined tax rules, tax assistant rules, flexible fields, and workflow configurations, or combinations thereof.

The method may also include normalizing the values of the plurality of features prior to implementing the outlier detection algorithm.

The graphical representation of the outlier value and outlier feature can be a radar chart that represents each of the plurality of features as radially extending axis, and includes a visually distinguishable depiction of the outlier feature and outlier value.

The outlier detection algorithm can be principal component analysis and the graphical representation is a two-dimensional plot of computed principal components of the plurality of features.

The generative language model can be a reasoning model configured to generate workflows.

The workflows can be formed by a plurality of nodes linked in a directed acyclic graph, each of the nodes having an associated agent configured to perform an operation associated with the node, a result of an operation of a prior node in the graph being passed to a subsequent node.

Using the above described systems and methods, users of a tax application virtual assistant program of a tax platform can create new tax related workflows using an agentic framework, and then analyze the generated workflows to determine aspects of those workflows that are outliers as compared to workflows used by other entities that use the platform. Further the workflows can be modified to address the gaps discovered by outlier detection, by pulling from a knowledge base to provide suggestions on what to populate and explanations of reasons for the proposed modifications. For convenience, suggestions regarding the proposed modifications can be accessed through the use of a query to a language model that is configured with a RAG architecture to access the knowledge base in databases on the platform. In this manner, the system can provide the recommendations for modifying the workflow to hew closer to customer segment averages, via a chat interface and accompanying graphical display that shows the shape of the customers workflow vs. the customer segment average. In this way, users can generate, visually inspect, validate, and improve the effectiveness of workflows using AI. Improvements of the workflows in this manner can help avoid errors associated with incorrect workflows and also can increase efficiency for inefficient workflows, thereby addressing the technical issues discussed above. In addition, a user may discover new features when adopting the modification proposals, thereby increasing the utility of the platform to the user. Using the systems and method above, improved workflows can be generated that reduce errors in misclassification of products or services, errors in compliance reports, mis-calculation and mis-payment of taxes due, and accounting errors. Further, the systems and methods described above can be used to generate workflows that run faster and more efficiently, and produce results that are easier to understand.

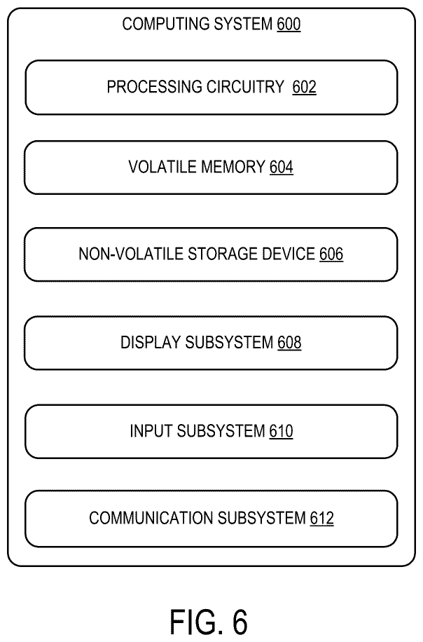

FIG. 6 schematically shows a non-limiting embodiment of a computing system 600 that can enact one or more of the methods and processes described above. Computing system 600 is shown in simplified form. Computing system 600 may embody the computing system 10 described above and illustrated in FIG. 1. Components of computing system 600 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 600 includes processing circuitry 602, volatile memory 604, and a non-volatile storage device 606. Computing system 600 may optionally include a display subsystem 608, input subsystem 610, communication subsystem 612, and/or other components not shown in FIG. 6.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 602 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 602.

Non-volatile storage device 606 includes one or more physical devices configured to hold instructions executable by the processing circuitry to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by processing circuitry 602 to temporarily store information during processing of software instructions. It will be appreciated that volatile memory 604 typically does not continue to store instructions when power is cut to the volatile memory 604.

Aspects of processing circuitry 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via processing circuitry 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with processing circuitry 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a processing circuitry and associated memory storing instructions that when executed by the processing circuitry cause the processing circuitry to:
implement a tax application virtual assistant program to:
receive a workflow creation command at a workflow orchestrator;
send a request to a workflow creation agent of a generative language model to thereby generate a new workflow in response to receiving the workflow creation command;
receive a verify workflow command;
identify a comparison set of workflows based on one or more comparison parameters;
encode, via a workflow feature encoder, a plurality of features extracted from the comparison set of workflows to generate a plurality of encoded features, wherein the plurality of encoded features comprise tax-related features relating to one or more of entity type, jurisdiction, facility type, facility location, exemption certificates, tax drivers, user defined tax rules, and tax assistant rules;
compute statistical values for the plurality of encoded features;
compute new workflow values for the plurality of encoded features for the new workflow;
compare the new workflow values to the statistical values to thereby identify an outlier value for an outlier feature of the plurality of encoded features; and
display a graphical representation of the outlier value and outlier feature.

2. The computing system of claim 1, wherein the processing circuitry is further configured to:
receive a modify workflow command; and
conduct retrieval augmented generation using the generative language model to thereby generate a modified new workflow.

3. The computing system of claim 1, wherein the statistical values are mean, median, mode, or combinations thereof for the values of the plurality of encoded features extracted from the comparison set of workflows, and are computed by the workflow feature encoder executed by the processing circuitry.

4. The computing system of claim 1, wherein the plurality of encoded features further comprise tax-related features relating to flexible fields, tax workflow configurations, or a combination thereof.

5. The computing system of claim 1, wherein comparing the new workflow values to the statistical values to thereby identify at least one outlier is performed by an outlier detection algorithm implemented by an outlier detection module executed by the processing circuitry.

6. The computing system of claim 1, wherein the processing circuitry is further configured to normalize the values prior to implementation of the outlier detection algorithm.

7. The computing system of claim 1, wherein the graphical representation of the outlier value and outlier feature is a radar chart that represents each of the plurality of encoded features as a radially extending axis, and includes a visually distinguishable depiction of the outlier feature and outlier value.

8. The computing system of claim 1, wherein the outlier detection algorithm is principal component analysis and the graphical representation is a two-dimensional plot of computed principal components of the plurality of encoded features.

9. The computing system of claim 1, wherein the generative language model is a reasoning model configured to generate workflows.

10. The computing system of claim 1, wherein each workflow is formed by a plurality of nodes linked in a directed acyclic graph, each of the nodes having an associated agent configured to perform an operation associated with the node, a result of an operation of a prior node in the directed acyclic graph being passed to a subsequent node.

11. A computerized method, comprising:
receiving a workflow creation command at a workflow orchestrator of a tax application virtual assistant program;
sending a request to a workflow creation agent of a generative language model to thereby generate a new workflow in response to receiving the workflow creation command;
receiving a verify workflow command;
identifying a comparison set of workflows based on one or more comparison parameters;
encoding a plurality of features extracted from the comparison set of workflows to generate a plurality of encoded features, wherein the plurality of encoded features comprise tax-related features relating to one or more of entity type, jurisdiction, facility type, facility location, exemption certificates, tax drivers, user defined tax rules, and tax assistant rules;
computing statistical values for the plurality of encoded features;
computing new workflow values for the plurality of encoded features for the new workflow;
implementing an outlier detection algorithm to compare the new workflow values to the statistical values and thereby identify an outlier value for an outlier feature of the plurality of encoded features; and
displaying a graphical representation of the outlier value and outlier feature.

12. The computerized method of claim 11, further comprising:
receiving a modify workflow command; and
conducting retrieval augmented generation using the generative language model to thereby generate a modified new workflow.

13. The computerized method of claim 11, wherein the statistical values are mean, median, mode, or combinations thereof for the values of the plurality of encoded features extracted from the comparison set of workflows, and are computed by a workflow feature encoder executed by the processing circuitry.

14. The computerized method of claim 11, wherein the plurality of encoded features further comprise tax-related features relating to flexible fields, tax workflow configurations, or a combination thereof.

15. The computerized method of claim 11, further comprising normalizing the values of the plurality of features prior to implementing the outlier detection algorithm.

16. The computerized method of claim 11, wherein the graphical representation of the outlier value and outlier feature is a radar chart that represents each of the plurality of encoded features as a radially extending axis, and includes a visually distinguishable depiction of the outlier feature and outlier value.

17. The computerized method of claim 11, wherein the outlier detection algorithm is principal component analysis and the graphical representation is a two-dimensional plot of computed principal components of the plurality of encoded features.

18. The computerized method of claim 11, wherein the generative language model is a reasoning model configured to generate workflows.

19. The computerized method of claim 11, wherein each workflow is formed by a plurality of nodes linked in a directed acyclic graph, each of the nodes having an associated agent configured to perform an operation associated with the node, a result of an operation of a prior node in the directed acyclic graph being passed to a subsequent node.

20. A computerized method, comprising:
receiving a workflow creation command at a workflow orchestrator of a tax application virtual assistant program;
sending a request to a workflow creation agent of a generative language model to thereby generate a new workflow in response to receiving the workflow creation command;
receiving a verify workflow command;
identifying a comparison set of workflows based on one or more comparison parameters;
encoding a plurality of features extracted from the comparison set of workflows to generate a plurality of encoded features, wherein the plurality of encoded features comprise tax-related features relating to one or more of entity type, jurisdiction, facility type, facility location, exemption certificates, tax drivers, user defined tax rules, and tax assistant rules;
computing statistical values for the plurality of encoded features;
computing new workflow values for the plurality of encoded features for the new workflow;
implementing an outlier detection algorithm to compare the new workflow values to the statistical values and thereby identify an outlier value for an outlier feature of the plurality of encoded features;
displaying a graphical representation of the outlier value and outlier feature;
receiving a modify workflow command; and
conducting retrieval augmented generation using the generative language model to thereby generate a modified new workflow, wherein
the statistical values are mean, median, mode, or combinations thereof for the values of the plurality of encoded features.
